(19) United States
(12) Patent Application Publication
(10) Pub. No.: US 2023/0311580 A1
(43) Pub. Date: Oct. 5, 2023

(54) TIRE

(71) Applicant: BRIDGESTONE CORPORATION, Chuo-ku, Tokyo (JP)

(72) Inventors: Shiori UDA, Chuo-ku, Tokyo (JP); Hiroshi KANNO, Chuo-ku, Tokyo (JP)

(21) Appl. No.: 18/024,507

(22) PCT Filed: Jun. 1, 2021
(86) PCT No.: PCT/JP2021/020846

§ 371 Date: Mar. 3, 2023

(30) Foreign Application Priority Data
Dec. 17, 2020 (JP) 2020-209690

(51) Int. Cl. B60C 11/13

(52) U.S. Cl. CPC B60C 11/13; B60C 2011/0355

(57) ABSTRACT

A tire comprising: a tread portion contacting a road surface; a groove provided in the tread portion; and a plurality of projections provided at groove side walls of the groove, wherein the plurality of projections are provided at least at any position within a region of from 40 to 60% of a groove depth of the groove side walls, and wherein, as seen in a cross-section in a width direction of the groove, an apex of the projection is positioned further toward a tread surface side of the tread portion than a width direction central portion of a base of the projection.

### TECHNICAL FIELD

The present disclosure relates to a tire having a groove in the tread portion.

### BACKGROUND ART

There have been proposed pneumatic tires whose purpose is the reduction of noise at the time of traveling (see, for example, Japanese Patent Application Laid-Open (JP-A) No. H06-99705).

In the pneumatic tire disclosed in JP-A No. H06-99705, an uneven portion is formed continuously along the groove length direction at the bottom portion of a groove, and the sound within the groove is diffusely reflected by the uneven portion. Further, the uneven portion is formed by convex portions, which are isosceles triangular in cross-section, being provided continuously.

### SUMMARY OF INVENTION

### Technical Problem

It has been thought to form uneven portions at the groove side walls in order to further reduce noise at the time of traveling.

The grooves of a tread portion are formed by rib-shaped rib portions that are provided at the mold that forms the tire. At the time of removing the tire from the mold, the rib portions move and slip-out along the depths of the grooves toward the opening portions of the grooves. However, if convex portions are provided at the groove side walls, it is easy for the convex portions to catch on the rib portions of the mold, and it is difficult to remove the tire from the mold at which molding was carried out. Therefore, some type of countermeasure thereto is required.

In view of the above-described circumstances, an object of the present disclosure is to provide a tire that can reduce noise at the time of traveling and that can be easily removed from a mold.

### Solution to Problem

A tire relating to a first aspect comprises: a tread portion contacting a road surface; a groove provided in the tread portion; and a plurality of projections provided at groove side walls of the groove, wherein the plurality of projections are provided at least at any position within a region of from 40 to 60% of a groove depth of the groove side walls, and, wherein, as seen in a cross-section in a width direction of the groove, an apex of the projection is positioned further toward a tread surface side of the tread portion than a width direction central portion of a base of the projection.

In the tire relating to the first aspect, the sound that is generated within the groove at the time when the tread portion contacts the road surface is diffusely reflected by the plural projections provided at the groove side walls, and, for example, noise such as air column resonance sound, air pumping noise and the like can be reduced.

Further, as seen in a cross-section in the width direction of the groove, the apex of the projection is positioned further toward the tread surface side of the tread portion than the width direction central portion of the base of the projection. Therefore, the angle of inclination of the side wall that is at the groove bottom side of the projection, with respect to a normal line that stands at the groove side wall, is large. Thus, in a case in which the rib portions of the mold move along the groove depth directions toward the groove opening portions, it is difficult for the rib portions to catch on the projections, and it is easy to pull the rib portions out from the grooves.

In a tire relating to a second aspect, in the tire relating to the first aspect, the projections are not formed at boundary surface portions at the groove side walls, the boundary surface portions contacting the road surface at a time at when the tread portion contacts the road surface and compressively deforms.

When the tread portion contacts the road surface, the tread portion is compressively deformed due to the vehicle weight. When the tread portion is compressively deformed, the groove side walls deform so as to bulge-out toward the groove inner side, and portions, which are at the tread portion tread surface sides, of the groove side walls contact the road surface. In particular, if chamfering is carried out on the corner portions that are formed by the tread portion tread surface and the groove side walls, it is easy for the chamfered portions to contact the road surface.

Given that the groove side wall portions, which contact the road surface at the time when the tread portion contacts the road surface and is compressively deformed, are boundary surface portions, in the tire relating to the second aspect, projections are not provided at the boundary surface portions. Therefore, at the time when the tire travels, the projections contacting the road surface is suppressed.

If plural projections were to contact the road surface, the ground-contact shape would be affected, and there would be the concern that, for example, the wet performance at the time of traveling on a wet surface would deteriorate.

The reason why the ground-contact shape is affected is that, in a case in which plural projections contact the road surface, the contact surface area with respect to the road surface is small as compared with a case in which a tread surface that is a smooth surface contacts the road surface.

However, in the tire relating to the second aspect, because the plural projections do not contact the road surface, a deterioration in the wet performance can be suppressed. Note that, because the ground-contact shape being affected is suppressed, a deterioration in not only the wet performance, but in the dry performance and the on-ice performance as well can be suppressed.

In a tire relating to a third aspect, in the tire relating to the first aspect or the second aspect, the projection is an aggregate projection that is structured to include a plurality of linear projections extending in a radial form from an origin.

In the tire relating to the third aspect, the projection is an aggregate projection that is structured to include plural linear projections that extend in a radial form from an origin. Therefore, as compared with, for example, linear projections that extend only in a uniform direction, it is easy to diffusely reflect sound, and the effect of reducing noise can be improved.

In a tire relating to a fourth aspect, in the tire of any one of the first aspect through the third aspect, the projections are further provided at a groove bottom of the groove.

In the tire relating to the fourth aspect, the projections are provided at the groove bottom of the groove as well. Therefore, the sound that hits the groove bottom also can be diffusely reflected, and the effect of reducing noise can be improved as compared with a case in which projections are not provided at the groove bottom.

In a tire relating to a fifth aspect, in the tire of any one of the first aspect through the fourth aspect, a height of the projection is set within a range of from 0.1 to 1.0 mm.

If the height of the projection is less than 0.1 mm, there are cases in which the effect of diffusely reflecting sound and reducing noise is insufficient.

On the other hand, if the height of the projection exceeds 1.0 mm, there are cases in which effects on the flow of water within the groove at the time of traveling on a wet surface are produced.

Accordingly, it is preferable that the height of the projection be set within the range of 0.1˜1.0 mm.

In a tire relating to a sixth aspect, in the tire of any one of the first aspect through the fifth aspect, the plurality of projections are provided densely at the groove side walls.

In the tire relating to the sixth aspect, because the plural projections are provided densely at the groove side walls, it is easy to diffusely reflect sound, and the effect of reducing noise can be improved, as compared with a case in which the projections are not provided densely.

### Advantageous Effects of Invention

As described above, in accordance with the tire of the present disclosure, there are the effects that noise at the time of traveling can be reduced, and the tire can be easily removed from a mold.

### BRIEF DESCRIPTION OF DRAWINGS

FIG. 1 is a cross-sectional view along a tire rotational axis, illustrating a tread portion of a tire relating to a first embodiment of the present disclosure.

FIG. 2 is a cross-sectional view in which the tread portion is cut along a groove width direction, and illustrates a groove that is formed in the tread portion.

FIG. 3 is a cross-sectional view illustrating projections provided at a groove side wall.

FIG. 4 is a cross-sectional view illustrating a groove side wall of the tire relating to a modified example.

FIG. 5 is a cross-sectional view illustrating the projection of the tire relating to another modified example.

FIG. 6 is a cross-sectional view illustrating the projection of the tire relating to yet another modified example.

FIG. 7 is a plan sectional view illustrating a groove side wall at which asterisk projections of a tire relating to a second embodiment are provided.

FIG. 8 is an enlarged plan view illustrating the asterisk projections.

FIG. 9A is a cross-sectional view of a linear projection.

FIG. 9B is a cross-sectional view of a linear projection relating to a comparative example in which α is 0°.

### DESCRIPTION OF EMBODIMENTS

### First Embodiment

A tire 10 relating to a first embodiment of the present disclosure is described hereinafter with reference to the drawings.

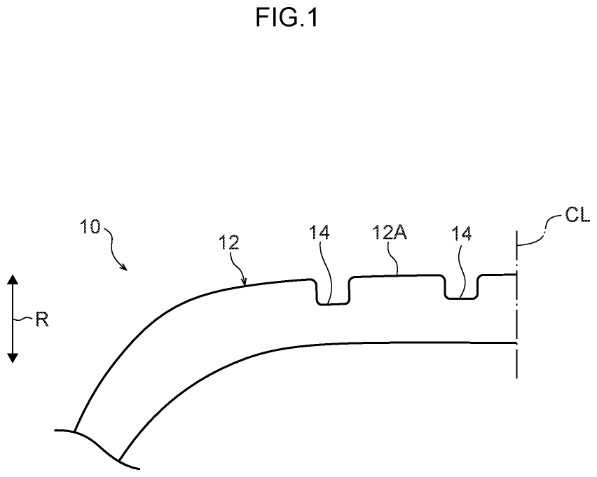

The tire 10 of the present embodiment illustrated in FIG. 1 is similar to a general pneumatic tire except for the structure of grooves 14 that are described later, and therefore, explanation relating to the internal structure of the tire 10 is omitted.

The grooves 14 that serve as main grooves for drainage extend along the tire circumferential direction in a tread surface 12A of a tread portion 12 of the tire 10.

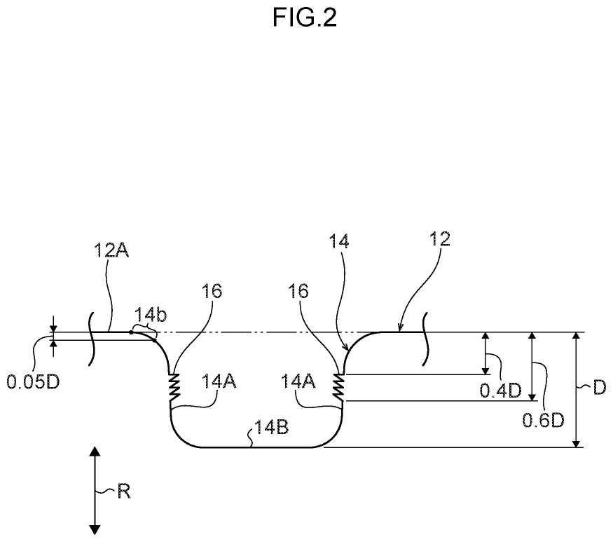

As illustrated in FIG. 2, plural projections 16 are formed in the groove 14 at groove side walls 14A at the groove width direction both sides. The projections 16 of the present embodiment are rib-shaped, and are formed along the length direction of the groove 14.

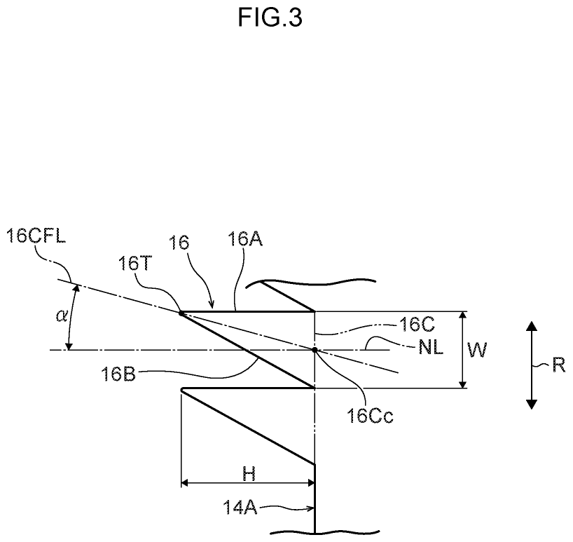

As illustrated in FIG. 3, as seen in a width direction cross-section of the groove 14, the projection 16 of the present embodiment is formed in a substantially triangular shape that is a shape tapered toward an apex 16T. Note that a side wall 16A of the projection 16 that is at the side of the tread surface 12A of the tread portion 12, and a side wall 16B that is at a groove bottom 14B side, are rectilinear as seen in cross-section, but may be curved.

The position of the apex 16T of the projection 16 is offset toward the tread surface 12A side (the upper side in the drawing of FIG. 3), with respect to a projection width direction center 16Cc of a base (the boundary portion between the projection 16 and the groove side wall 14A illustrated by the two-dot chain line) 16C of the projection 16. In other words, the apex 16T is positioned further toward the tread surface 12A side than normal line NL that stands at the groove side wall 14A at the projection width direction center 16Cc of the base 16C.

Note that, given that the angle formed by the normal line NL and projection virtual central line 16CFL, which connects the apex 16T and the projection width direction center 16Cc of the base 16C, is α, α is greater than 0° and is preferably set within the range of 5°˜40°.

Further, height H of the projection 16, which is measured in the direction orthogonal to the groove side wall 14A, is preferably set within the range of 0.1˜1.0 mm. The ratio of the height H of the projection 16 to width W of the base 16C of the projection 16 is not particularly limited, but is preferably set within the range of H/W=0.8˜6.0.

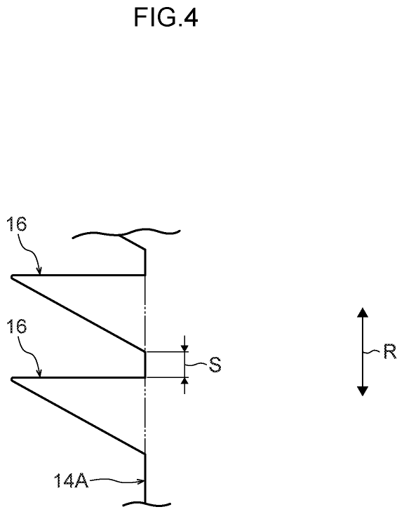

In the present embodiment, the plural projections 16 are provided continuously without gaps therebetween in the depth direction of the groove side walls 14A. In other words, the plural projections 16 are provided densely. Note that, the plural projections are provided continuously without gaps therebetween as illustrated in FIGS. 2 and 3, but, as illustrated in FIG. 4, a slight gap S may be provided between the projection 16 and the projection 16. Note that in the present embodiment, the projections 16 are considered to be dense if the dimension of the gap S is less than or equal to W×½ (as an example of an actual dimension, less than or equal to 0.3 mm).

Note that, as illustrated in FIG. 2, at the tire 10 of the present embodiment, the projections 16 are provided in the entire range of 40˜60% of groove depth D of the groove side walls 14A. However, it suffices for the range in which the projections 16 are provided to be provided at any region that is within the range of 40˜60% of the groove depth D.

Further, given that the portion of the groove side wall 14A, which portion contacts the road surface at the time when the tread portion 12 contacts the ground, is boundary surface portion 14b, it is better to avoid providing the projections 16 at the boundary surface portion 14b. In the present embodiment, the boundary surface portion 14b means the region of the groove side wall 14A that is to 5% of the groove depth D from the tread surface 12A.

Note that the “the tread portion 12 contacts the ground” that is mentioned above is when a tire that is a pneumatic tire is mounted to the standard rim prescribed in the JATMA YEAR BOOK (2020, the standards of The Japan Automobile Tyre Manufacturers Association, Inc.), and is filled to an internal pressure of 100% of the air pressure (maximum air pressure) corresponding to the maximum load capacity (the loads that are in bold type in the Internal Pressure—Load Capacity table of correspondence) in the Applicable Size/Ply Rating in the JATMA YEAR BOOK, and is loaded to the maximum load capacity. When TRA standards or ETRTO standards are used in the region of usage or the region of manufacture, those standards are followed.

Note that the boundary portion between the groove side wall 14A and the tread surface 12A of the tread portion 12 may be chamfered as illustrated in FIG. 2, or may not be chamfered.

(Operation, Effects)

Operation, effects of the tire 10 of the present embodiment are described next.

At the tire 10 of the present embodiment, the sound that is generated within the grooves 14 at the time when the tire 10 is used in traveling and the tread portion 12 contacts the road surface is diffusely reflected by the plural projections 16 provided at the groove side walls 14A. Therefore, noise such as air column resonance sound, air pumping noise and the like can be reduced.

Further, as seen in a width direction cross-section of the groove, the apex 16T of the projection 16 is positioned further toward the side of the tread surface 12A of the tread portion 12 than the projection width direction center 16Cc of the base 16C of the projection 16. Therefore, when comparing the side wall 16A at the tread surface side and the side wall 16B at the groove bottom side of the projection 16, the angle of inclination, with respect to the normal line NL that stands at the groove side wall 14A, of the side wall 16B that is at the groove bottom side of the projection 16 is greater than that of the side wall 16A that is at the tread surface side. In other words, the angle of inclination of the side wall 16B that is at the groove bottom side is large in order to facilitate removal from the mold. Therefore, in a case in which the rib portions (not illustrated) of the mold that vulcanization-molds the tire 10 move along the groove depth directions toward the groove opening portions, it is difficult for the rib portions to catch on the projections 16, and it is easy to pull the rib portions out from the grooves 14. In other words, it is easy to remove the tire 10 from the mold.

Moreover, at the tire 10 of the present embodiment, the projections 16 are not provided at the boundary surface portions 14b that are partial regions at the tread surface 12A sides of the groove side walls 14A of the groove 14. Therefore, when the tire travels, the projections 16 contacting the road surface and affecting the ground-contact shape can be suppressed, e.g., affecting the wet performance, the dry performance, the on-ice performance, and the like can be suppressed.

Note that if the angle α that is formed by the normal line NL and the projection virtual central line 16CFL, which connects the apex 16T and the projection width direction center 16Cc of the base 16C, does not exceed 0°, it is difficult to remove the tire 10 from the mold. On the other hand, if the angle α exceeds 40°, the apparent length of the projection 16 is long, the resistance to pulling-out is large, and there is the concern that the rubber will be damaged.

Accordingly, it is preferable that the angle α at the projection 16 be set within the range of from 5° to 40°.

Further, if the height H of the projection 16, which is measured in the direction orthogonal to the groove side wall 14A, is less than 0.1 mm, there are cases in which the effect of diffusely reflecting the sound and reducing the noise is insufficient.

On the other hand, if the height of the projection exceeds 1.0 mm, there are cases in which effects on the flow of water within the groove 14 at the time of traveling on a wet surface are produced.

Accordingly, it is preferable to set the height H of the projection 16 within the range of from 0.1 mm to 1.0 mm. Note that it is more preferable to set the height H of the projection 16 within the range of from 0.2 mm to 0.8 mm.

Further, if the ratio H/W of the height H of the projection 16 and the width W of the base 16C of the projection 16 is less than 0.8, it is difficult to diffusely reflect sound, and there are cases in which the effect of reducing noise is insufficient.

On the other hand, if the ratio H/W exceeds 6.0, the bending rigidity in the groove depth direction of the projections 16 is low, and there is the concern that the projections 16 will be damaged at the time of mold removal.

Accordingly, it is preferable to set the ratio H/W of the height H of the projection 16 and the width W of the base 16C of the projection 16 to be in the range of 0.8˜6.0.

Note that, as illustrated in FIG. 2, at the tire 10 of the present embodiment, the projections 16 are provided in the entire range of from 40 to 60% of the groove depth D of the groove side walls 14A. However, the range in which the projections 16 are provided may be provided at other than the range of 40˜60% of the groove depth D of the groove side walls 14A (but while avoiding the boundary surface portions 14b), and may be formed at the groove bottom 14B. There are no particular stipulations on the angle α for the projections 16 that are provided at the groove bottom 14B.

By providing the projections 16 also at other than the range of from 40 to 60% of the groove depth D of the groove side walls 14A or providing the projections 16 at the groove bottom 14B, the sound within the groove 14 can be diffusely reflected better, and noise can be reduced more.

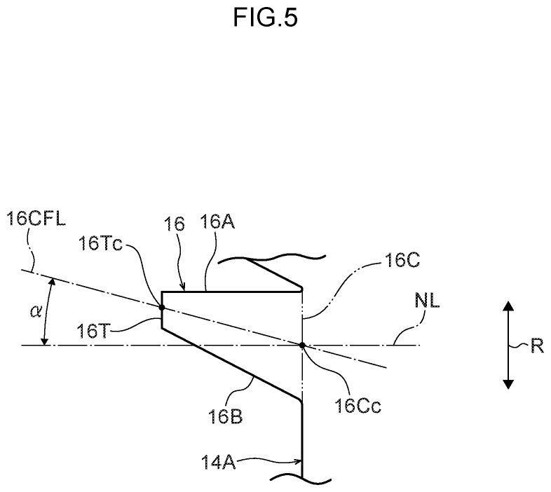

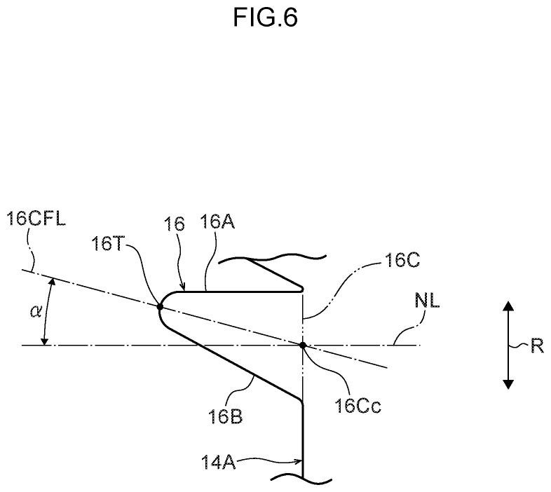

Note that, although the cross-sectional shape of the projections 16 of the present embodiment is substantially triangular, the cross-sectional shape of the projections 16 is not limited to triangular, and may be trapezoidal as illustrated in FIG. 5 as an example. In a case in which the apex 16T of the projection 16 is a flat surface, the line, which connects the projection width direction center 16Cc of the base 16C and a width direction central portion 16Tc of the apex 16T, is the projection virtual central line 16CFL. Further, the apex 16T of the projection 16 may be circular-arc-shaped (a curved shape) such as illustrated in FIG. 6.

### Second Embodiment

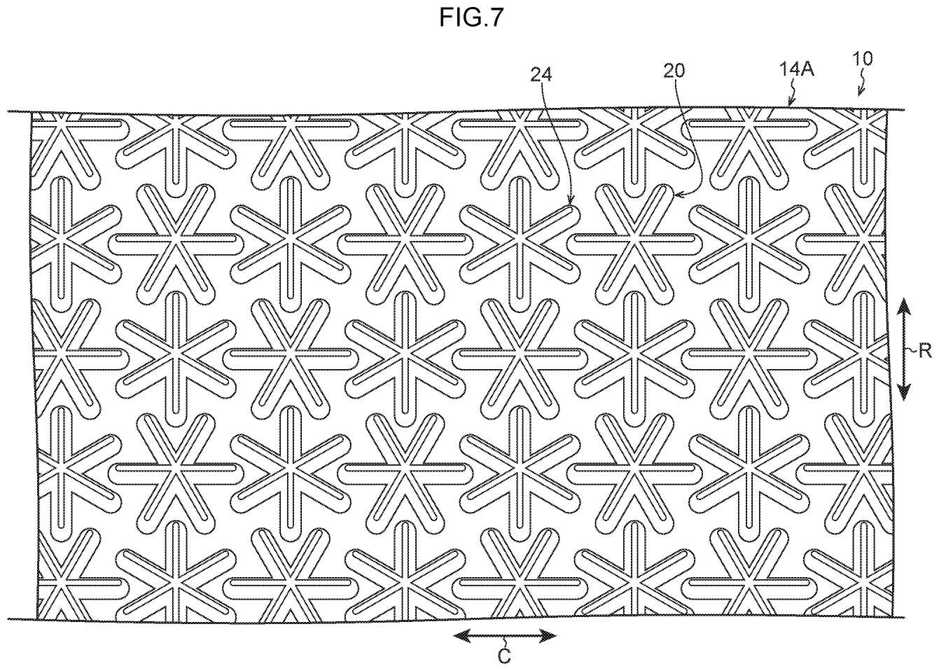

The tire 10 relating to the second embodiment of the present disclosure is described next in accordance with FIG. 7 through FIG. 9A. Note that structures that are the same as those of the first embodiment are denoted by the same reference numerals, and description thereof is omitted.

Instead of the plural projections 16 of the first embodiment, as illustrated in FIG. 7, plural asterisk projections 20 and asterisk projections 24 are formed at the groove side walls 14A of the grooves 14 of the tire 10 of the present embodiment, alternately in a tire circumferential direction C and a tire radial direction R with gaps therebetween.

The asterisk projections 20 and the asterisk projections 24 are examples of the aggregate projections of the present disclosure.

The asterisk projection 20 has plural linear projections 22 that extend rectilinearly in radial directions from origin O1. In other words, the plural linear projections 22 extend in respectively different directions from the origin O1. In the present embodiment, the plural linear projections 22 are provided so as to form angles of 60° around the origin O1.

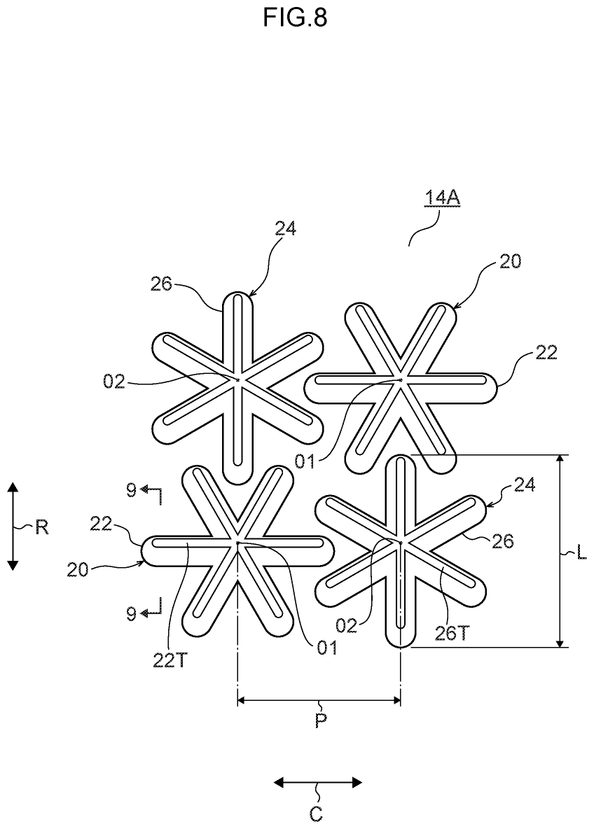

At the asterisk projection 20, the position of apex 22T of each linear projection 22 of the asterisk projection 20 is near to the tread surface 12A side (the upper sides in the drawings of FIGS. 7 and 8).

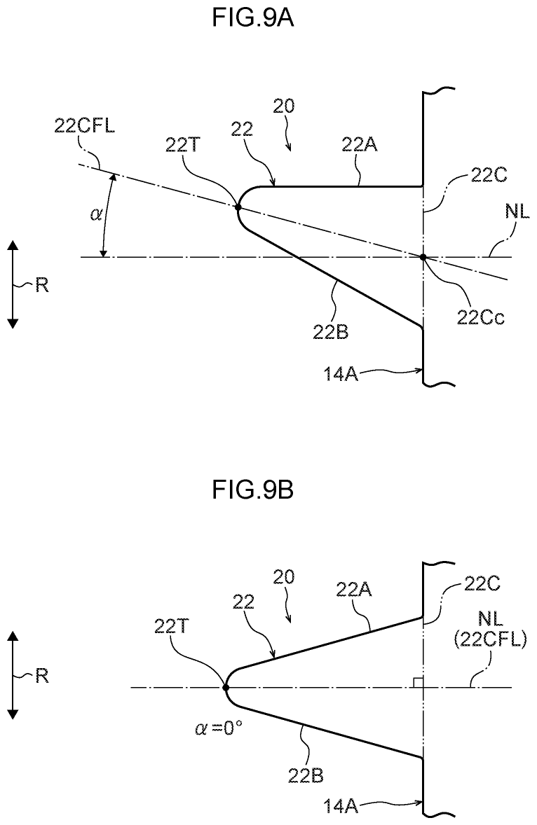

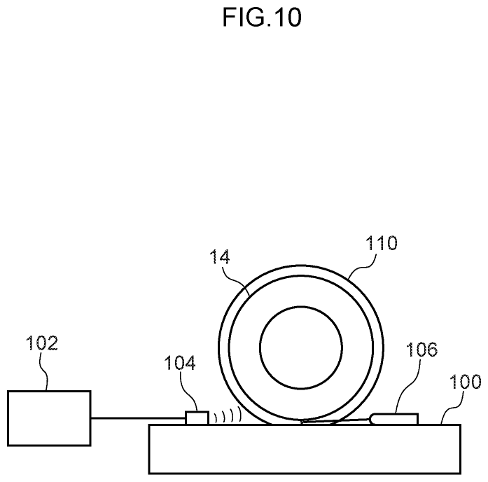

The cross-section when the linear projection 22, which extends along the tire circumferential direction C, of the asterisk projection 20 is cut at a right angle to the tire circumferential direction C is illustrated in FIG. 9A. The position of the apex 22T of the linear projection 22 that extends in the tire circumferential direction C is near to the tread surface 12A side (the upper sides in the drawings of FIG. 9). In other words, the apex 22T is positioned further toward the tread surface 12A side than the normal line NL that stands at the groove side wall 14A at a projection width direction center 22Cc of base 22C of the linear projection 22. Moreover, in other words, the linear projection 22 that extends along the tire circumferential direction C is inclined toward the tread surface 12A side, and the other linear projections 22 also are similarly inclined toward the tread surface 12A side.

Further, the asterisk projection 24 has plural linear projections 26 that extend rectilinearly in radial directions from origin O2. In other words, the plural linear projections 26 extend in respectively different directions from the origin O2. In the present embodiment, the plural linear projections 26 are provided so as to form angles of 60° around the origin O2.

Note that, in the same way as the asterisk projections 20, at the asterisk projections 24 as well, the position of apex 26T of the linear projection 26 is near to the tread surface 12A side (the upper sides in the drawings of FIGS. 7 and 8).

The interval (hereinafter called “interval P”) between the origin O1 of one asterisk projection 20 and the origin O2 of another asterisk projection 24 that are adjacent to one another in the tire radial direction R and the tire circumferential direction C is preferably set within the range of from 0.2 mm to 1.0 mm.

In the present embodiment, if the interval P is less than or equal to 1.0 mm, the asterisk projections 20 are considered to be dense.

Further, longest extension length L at the asterisk projection 20 (the same holds for the asterisk projection 24 as well) is preferably set to be longer than the interval P.

In the present embodiment, the longest extension lengths L at the asterisk projections 20, 24 are set to be longer than the interval P, and the linear projection 22 of the asterisk projection 20 is inserted between the linear projection 26 and the linear projection 26 of the adjacent asterisk projection 24, and the linear projection 26 of the asterisk projection 24 is inserted between the linear projection 22 and the linear projection 22 of the adjacent asterisk projection 20.

(Operation, Effects)

Operation, effects of the tire 10 relating to the present embodiment are described next.

In the same way as the projections 16 of the first embodiment,

the asterisk projections 20 and the asterisk projections 24 of the present embodiment also diffusely reflect the sound that is generated within the grooves 14, and therefore, can reduce noise such as air column resonance sound, air pumping noise and the like.

Further, at the tire 10 of the present embodiment, the linear projections 22 of the asterisk projections 20 provided at the groove side walls 14A extend from the origin O1 in respectively different directions, and further, the linear projections 26 of the asterisk projections 24 extend from the origin O2 in respectively different directions. Therefore, it is easier to diffusely reflect noise, and the noise reducing effect can be made to be better, than the tire 10 of the first embodiment that is provided with the projections 16 that extend in the same direction.

Further, at the tire 10 of the present embodiment, the longest extension lengths L at the asterisk projections 20, 24 are set to be longer than the intervals P, and the linear projection 22 of the asterisk projection 20 is inserted between the linear projection 26 and the linear projection 26 of the adjacent asterisk projection 24, and the linear projection 26 of the asterisk projection 24 is inserted between the linear projection 22 and the linear projection 22 of the adjacent asterisk projection 20. Accordingly, it is easy to place the asterisk projections 20 and the asterisk projections 24 close to one another, and the plural asterisk projections 20 and asterisk projections 24 can be arranged densely. By arranging the asterisk projections 20 and the asterisk projections 24 densely in this way, noise at the time of traveling can be reduced more.

Further, the asterisk projection 20 on the whole and the asterisk projection 24 on the whole are inclined toward the tread surface 12A side of the tread portion 12.

As an example, as illustrated in FIG. 9A, at the linear projection 22 that extends in the tire circumferential direction, the angle of inclination of a side surface 22B at the groove bottom side (with respect to the normal line NL that stands at the groove side wall 14A) is made large in order to facilitate removal from the mold (compare with FIG. 9B in which α=0°). Therefore, in a case in which the rib portions (not illustrated) of the mold that vulcanization-molds the tire 10 move along the groove depth directions toward the groove opening portions, it is difficult for the rib portions to catch on the linear projections 22, and it is easy to pull the rib portions out from the grooves 14.

Accordingly, in the same way as the tire 10 of the first embodiment, the tire 10 of the present embodiment as well can easily be removed from the mold at the time of manufacturing, and the moldability thereof can be improved.

Note that, although the asterisk projections 20 are structured by six of the linear projections 22, and the asterisk projections 24 are structured by six of the linear projections 26, the number of the linear projections 22 that structure the asterisk projections 20 and the number of the linear projections 26 that structure the asterisk projections 24 may be 5 or less or may be 7 or more.

Although the linear projections 22 that structure the asterisk projections 20 and the linear projections 26 that structure the asterisk projections 24 are rectilinear as seen in plan view, they may be curved.

Although the asterisk projections 20 and the asterisk projections 24 are separate, the linear projections 22 of the asterisk projections 20 and the linear projections 26 of the asterisk projections 24 may be connected together.

The linear projections 22 of the asterisk projections 20 and the linear projections 26 of the asterisk projections 24 may be the same lengths respectively, or may be different lengths respectively.

### Other Embodiments

Although embodiments of the present disclosure have been described above, the present disclosure is not limited to the above, and can, of course, be implemented by being modified in various ways other than the above, within a scope that does not depart from the gist thereof.

The grooves in which the projections 16 are provided are not limited to the grooves that extend along the tire circumferential direction, and may be grooves that extend along the tire width direction (so-called lug grooves) or grooves that are inclined with respect to the tire circumferential direction, or may be grooves that extend in zigzag forms or grooves that extend so as to be curved, and can be applied to all grooves that generate noise regardless of the size (the width, the depth) of the groove and the form thereof when the tread portion is seen in plan view.

The type of the tire to which the present disclosure is applied does not matter, and may be a tire for a passenger vehicle, for a truck/bus, for a motorcycle, or the like. Further, the tire to which the present disclosure is applied is not limited to a pneumatic tire, and may be a non-pneumatic tire (a solid tire) that is not filled with air. The present disclosure can be applied to any tire provided that is a tire having a groove in the tread portion thereof.

The disclosure of Japanese Patent Application No. 2020-209690 filed on Dec. 17, 2020 is, in its entirety, incorporated by reference into the present specification. All publications, patent applications, and technical standards mentioned in the present specification are incorporated by reference into the present specification to the same extent as if such individual publication, patent application, or technical standard was specifically and individually indicated to be incorporated by reference.

1. A tire comprising:
a tread portion contacting a road surface;
a groove provided in the tread portion; and
a plurality of projections provided at groove side walls of the groove,
wherein the plurality of projections are provided at least at any position within a region of 40˜60% of a groove depth of the groove side walls, and
as seen in a cross-section in a width direction of the groove, an apex of the projection is positioned further toward a tread surface side of the tread portion than a width direction central portion of a base of the projection.

2. The tire of claim 1, wherein the projections are not formed at boundary surface portions at the groove side walls, which boundary surface portions contact the road surface at a time when the tread portion contacts the road surface and compressively deforms.

3. The tire of claim 1, wherein the projection is an aggregate projection that is structured to include a plurality of linear projections extending in a radial form from an origin.

4. The tire of claim 1, wherein the projections are further provided at a groove bottom of the groove.

5. The tire of claim 1, wherein a height of the projection is set within a range of 0.1˜1.0 mm.

6. The tire of claim 1, wherein the plurality of projections are provided densely at the groove side walls.

7. The tire of claim 2, wherein the projection is an aggregate projection that is structured to include a plurality of linear projections extending in a radial form from an origin.

8. The tire of claim 2, wherein the projections are further provided at a groove bottom of the groove.

9. The tire of claim 3, wherein the projections are further provided at a groove bottom of the groove.

10. The tire of claim 2, wherein a height of the projection is set within a range of 0.1˜1.0 mm.

11. The tire of claim 3, wherein a height of the projection is set within a range of 0.1˜1.0 mm.

12. The tire of claim 4, wherein a height of the projection is set within a range of 0.1˜1.0 mm.

13. The tire of claim 2, wherein the plurality of projections are provided densely at the groove side walls.

14. The tire of claim 3, wherein the plurality of projections are provided densely at the groove side walls.

15. The tire of claim 4, wherein the plurality of projections are provided densely at the groove side walls.

16. The tire of claim 5, wherein the plurality of projections are provided densely at the groove side walls.
